(19) United States
(12) Patent Application Publication
(10) Pub. No.: US 2025/0280321 A1
(43) Pub. Date: Sep. 4, 2025

(54) BUFFER STATUS REPORTING

(71) Applicant: QUALCOMM Incorporated, San Diego, CA (US)

(72) Inventors: Zhikun WU, Beijing (CN); Ahmed ELSHAFIE, San Diego, CA (US); Yuchul KIM, San Diego, CA (US); Huilin XU, Temecula, CA (US); Linhai HE, San Diego, CA (US); Seyedkianoush HOSSEINI, San Diego, CA (US); Yu ZHANG, San Diego, CA (US)

(21) Appl. No.: 18/857,986

(22) PCT Filed: Jul. 4, 2022
(86) PCT No.: PCT/CN2022/103585

§ 371 Date: Oct. 18, 2024

(51) Int. Cl. H04W 28/02; H04L 1/00

(52) U.S. Cl. CPC H04W 28/0278; H04L 1/0006

(57) ABSTRACT

Some techniques described herein provide a buffer status report (BSR) medium access control control element (MAC-CE) associated with communication between a user equipment (UE) and one or more devices (such as one or more zero-power communication devices) associated with the UE. At least one of a logical channel group field (if present in the MAC-CE) or a buffer size field of the MAC-CE (if present in the MAC-CE) may be based on the MAC-CE being associated with communication between the UE and the one or more devices. By providing the BSR MAC-CE, the UE can report parameters regarding the one or more devices associated with the UE, such as a quantity of the one or more devices, a device type of the one or more devices, a buffer size, or the like. These parameters may assist in determining a resource allocation based on the BSR MAC-CE.

### FIELD OF THE DISCLOSURE

Aspects of the present disclosure generally relate to wireless communication and to techniques and apparatuses for buffer status reporting.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. 5G, which may be referred to as New Radio (NR), is a set of enhancements to the LTE mobile standard promulgated by the 3GPP. 5G is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in 4G, 5G, and other radio access technologies remain useful.

### SUMMARY

A user equipment (UE) may communicate with one or more devices, such as passive Internet of Things (IoT) devices or radio frequency identification (RFID) tags, among other examples. The one or more devices may not have sufficient power to communicate directly with the network. The UE may request resources for communication by transmitting a buffer status report (BSR) medium access control control element (MAC-CE). The UE may use resources, granted by a network node, for communication with the one or more devices. However, traditional BSRs, such as those associated with Uu communication (e.g., communication between the UE and a radio access network) may not be configured to convey information regarding the one or more devices. Without information regarding the one or more devices associated with the UE, scheduling of resources for the UE may be sub-optimal and may negatively affect operation of devices such as passive communication devices.

Some techniques described herein provide a MAC-CE associated with communication between a UE and one or more devices (such as one or more passive communication devices) associated with the UE. At least one of a logical channel group field (if present in the MAC-CE) or a buffer size field of the MAC-CE (if present in the MAC-CE) may be based at least in part on the MAC-CE being associated with communication between the UE and the one or more devices. The MAC-CE associated with communication between the UE and one or more devices is referred to as a zero-power communication BSR MAC-CE for ease of reference, though it should be understood that the zero-power communication BSR MAC-CE can convey information regarding non-passive communication devices. By providing the zero-power communication BSR MAC-CE, the UE can convey information regarding the one or more devices associated with the UE, such as a quantity of the one or more devices, a device type of the one or more devices, or the like. Thus, scheduling of resources for UEs associated with passive communication devices is improved, and the operation of passive communication devices (such as communications and energy harvesting) is improved.

Some aspects described herein relate to a method of wireless communication performed by a UE. The method may include transmitting a MAC-CE associated with communication between the UE and one or more devices associated with the UE, wherein at least one of a logical channel group (LCG) field or a buffer size field of the MAC-CE is based at least in part on the MAC-CE being associated with communication between the UE and the one or more devices. The method may include communicating based at least in part on the MAC-CE.

Some aspects described herein relate to a method of wireless communication performed by a network node. The method may include obtaining a MAC-CE associated with communication between a UE and one or more devices associated with the UE, wherein at least one of an LCG field or a buffer size field of the MAC-CE is based at least in part on the MAC-CE being associated with communication between the UE and the one or more devices. The method may include outputting one or more grants based at least in part on the MAC-CE.

Some aspects described herein relate to a UE for wireless communication. The UE may include a memory and one or more processors coupled to the memory. The one or more processors may be configured to transmit a MAC-CE associated with communication between the UE and one or more devices associated with the UE, wherein at least one of an LCG field or a buffer size field of the MAC-CE is based at least in part on the MAC-CE being associated with communication between the UE and the one or more devices. The one or more processors may be configured to communicate based at least in part on the MAC-CE.

Some aspects described herein relate to a network node for wireless communication. The network node may include a memory and one or more processors coupled to the memory. The one or more processors may be configured to obtain a MAC-CE associated with communication between a UE and one or more devices associated with the UE, wherein at least one of an LCG field or a buffer size field of the MAC-CE is based at least in part on the MAC-CE being associated with communication between the UE and the one or more devices. The one or more processors may be configured to output one or more grants based at least in part on the MAC-CE.

Some aspects described herein relate to a non-transitory computer-readable medium that stores a set of instructions for wireless communication by a UE. The set of instructions, when executed by one or more processors of the UE, may cause the UE to transmit a MAC-CE associated with communication between the UE and one or more devices associated with the UE, wherein at least one of an LCG field or a buffer size field of the MAC-CE is based at least in part on the MAC-CE being associated with communication between the UE and the one or more devices. The set of instructions, when executed by one or more processors of the UE, may cause the UE to communicate based at least in part on the MAC-CE.

Some aspects described herein relate to a non-transitory computer-readable medium that stores a set of instructions for wireless communication by a network node. The set of instructions, when executed by one or more processors of the network node, may cause the network node to obtain a MAC-CE associated with communication between a UE and one or more devices associated with the UE, wherein at least one of an LCG field or a buffer size field of the MAC-CE is based at least in part on the MAC-CE being associated with communication between the UE and the one or more devices. The set of instructions, when executed by one or more processors of the network node, may cause the network node to output one or more grants based at least in part on the MAC-CE.

Some aspects described herein relate to an apparatus for wireless communication. The apparatus may include means for transmitting a MAC-CE associated with communication between the UE and one or more devices associated with the UE, wherein at least one of an LCG field or a buffer size field of the MAC-CE is based at least in part on the MAC-CE being associated with communication between the UE and the one or more devices. The apparatus may include means for communicating based at least in part on the MAC-CE.

Some aspects described herein relate to an apparatus for wireless communication. The apparatus may include means for obtaining a MAC-CE associated with communication between a UE and one or more devices associated with the UE, wherein at least one of an LCG field or a buffer size field of the MAC-CE is based at least in part on the MAC-CE being associated with communication between the UE and the one or more devices. The apparatus may include means for outputting one or more grants based at least in part on the MAC-CE.

Aspects generally include a method, apparatus, system, computer program product, non-transitory computer-readable medium, user equipment, base station, wireless communication device, network entity, network node, and/or processing system as substantially described with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of power consumption associated with passive communication devices, in accordance with the present disclosure.

FIG. 5 is a diagram illustrating an example of resource allocations for passive communication devices, in accordance with the present disclosure.

FIG. 6 is a diagram illustrating an example of signaling associated with a passive communication buffer status report medium access control control element, in accordance with the present disclosure.

FIG. 7 is a flowchart of an example method of wireless communication, in accordance with the present disclosure.

FIG. 8 is a flowchart of an example method of wireless communication, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

FIG. 11 is a diagram illustrating an example of a hardware implementation for an apparatus employing a processing system, in accordance with the present disclosure.

FIG. 12 is a diagram illustrating an example of a hardware implementation for an apparatus employing a processing system, in accordance with the present disclosure.

### DETAILED DESCRIPTION

The detailed description set forth below in connection with the appended drawings is intended as a description of various configurations and is not intended to represent the configurations in which the concepts described herein may be practiced. The detailed description includes specific details for the purposes of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, or the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, or the like, whether referred to as software, firmware, middleware, microcode, hardware description language, or otherwise.

Accordingly, in one or more example embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

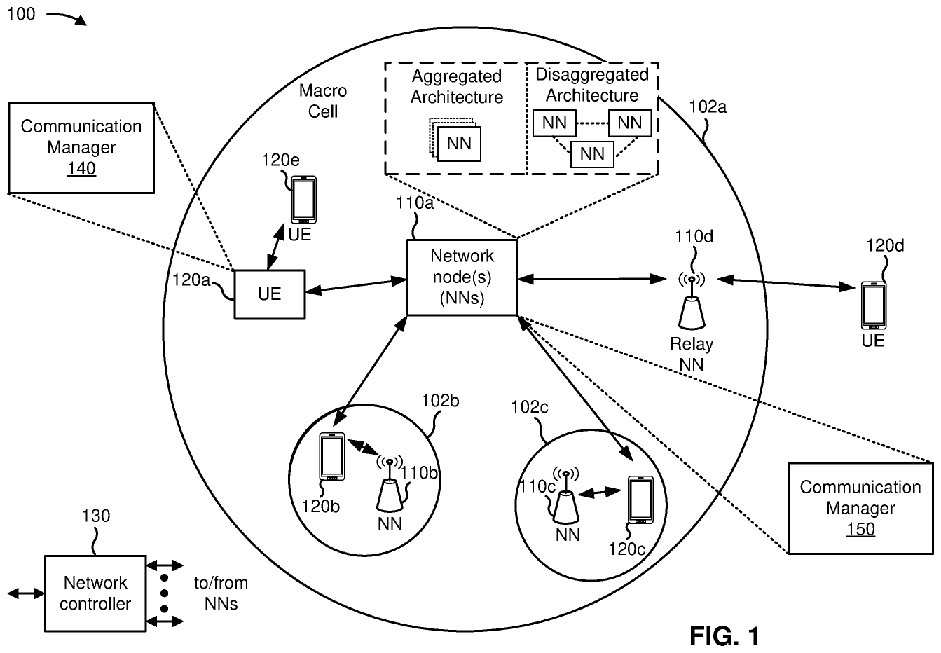

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing 284 that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHZ), FR4 (52.6 GHz-114.25 GHZ), and FR5 (114.25 GHz-300 GHz). Each of these higher frequency bands falls within the EHF band.

With these examples in mind, unless specifically stated otherwise, the term “sub-6 GHZ,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may transmit a medium access control (MAC) control element (MAC-CE) associated with communication between the UE and one or more devices associated with the UE, wherein at least one of a logical channel group (LCG) field or a buffer size field of the MAC-CE is based at least in part on the MAC-CE being associated with communication between the UE and the one or more devices; and communicate based at least in part on the MAC-CE. Additionally, or alternatively, the communication manager 140 may perform one or more other operations described herein.

In some aspects, the network node may include a communication manager 150. As described in more detail elsewhere herein, the communication manager 150 may obtain a MAC-CE associated with communication between a UE and one or more devices associated with the UE, wherein at least one of an LCG field or a buffer size field of the MAC-CE is based at least in part on the MAC-CE being associated with communication between the UE and the one or more devices; and output one or more grants based at least in part on the MAC-CE. Additionally, or alternatively, the communication manager 150 may perform one or more other operations described herein.

As indicated above, FIG. 1 is provided as an example. Other examples may differ from what is described with regard to FIG. 1.

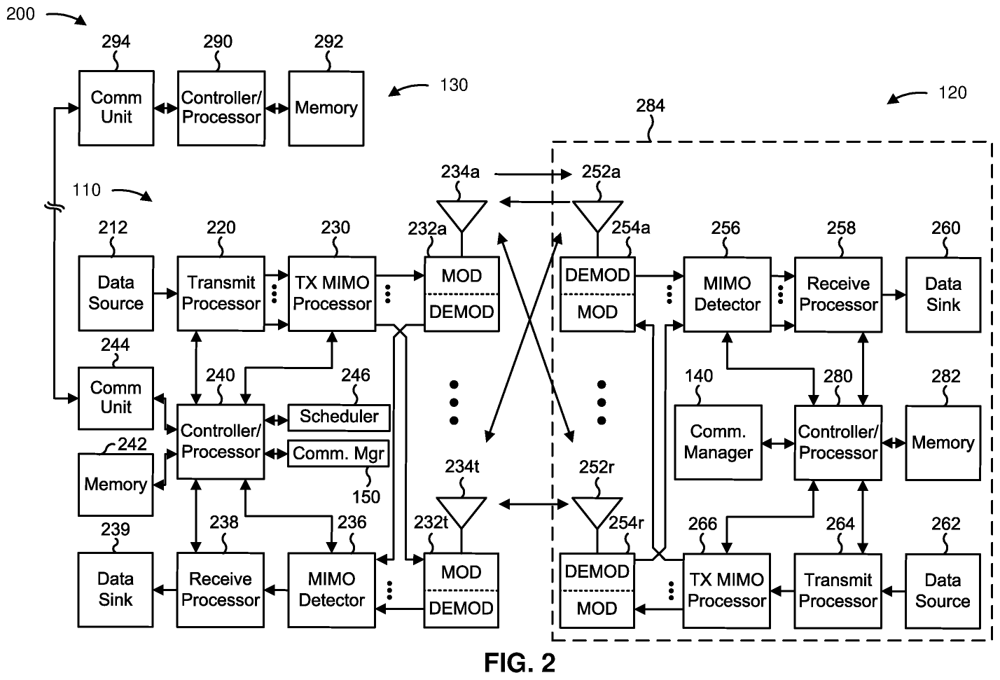

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein.

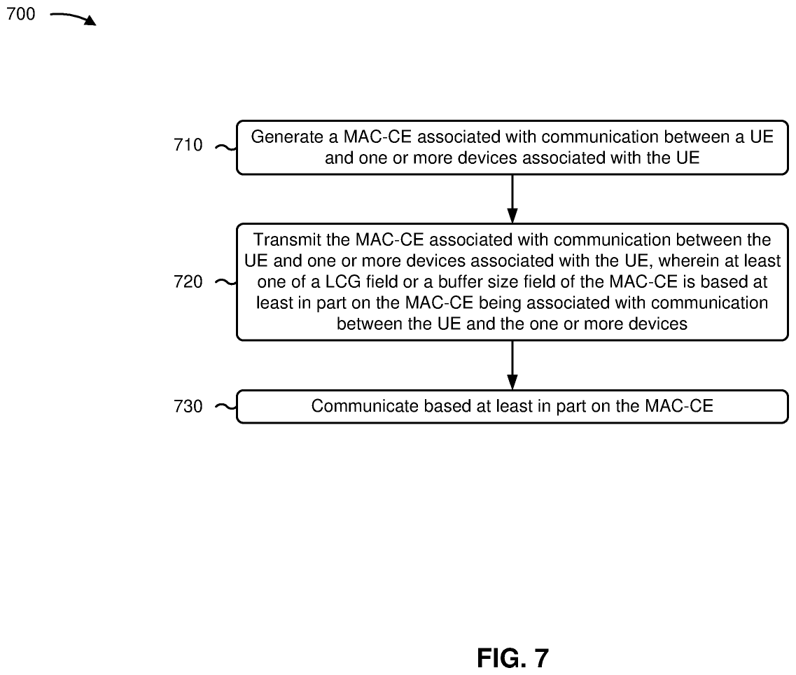

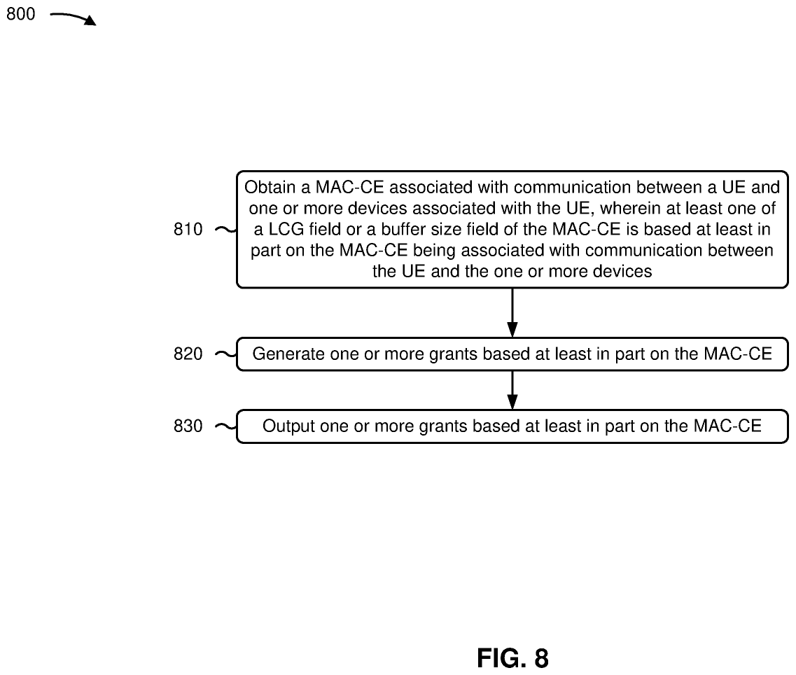

The controller/processor 240 of the network node 110, the controller/processor 280 of the UE 120, and/or any other component(s) of FIG. 2 may perform one or more techniques associated with buffer status reporting, as described in more detail elsewhere herein. For example, the controller/processor 240 of the network node 110, the controller/processor 280 of the UE 120, and/or any other component(s) of FIG. 2 may perform or direct operations of, for example, method 700 of FIG. 7, method 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, method 700 of FIG. 7, method 800 of FIG. 8, and/or other processes as described herein. In some examples, executing instructions may include running the instructions, converting the instructions, compiling the instructions, and/or interpreting the instructions, among other examples.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station (BS), a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

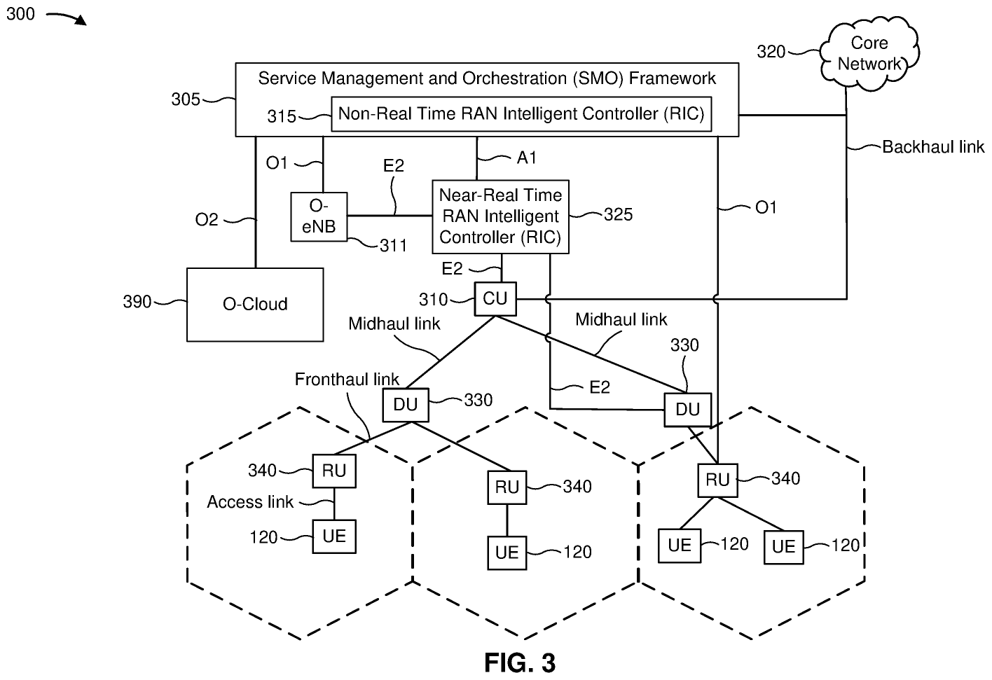

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

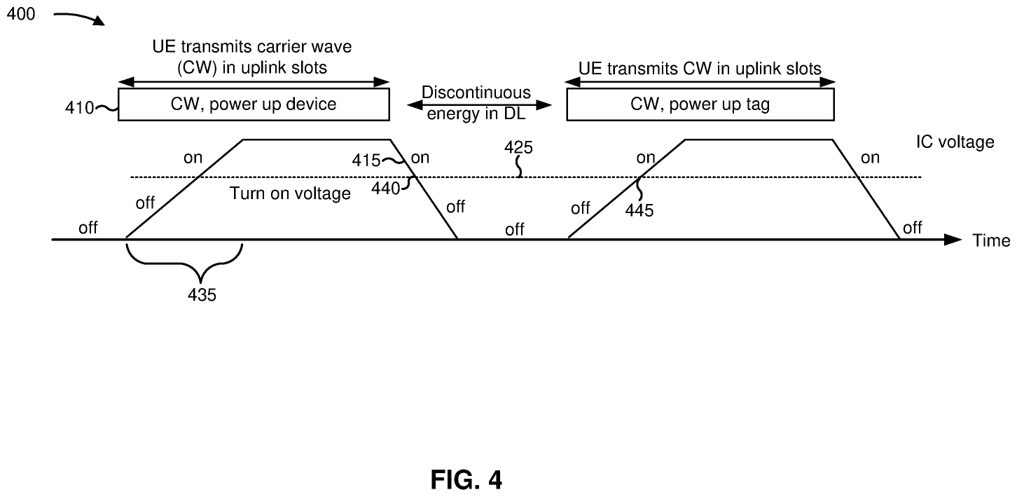

FIG. 4 is a diagram illustrating an example 400 of power consumption associated with a zero-power communication device, in accordance with the present disclosure. Example 400 illustrates power consumption associated with a zero-power communication device, such as a passive or semi-passive communication device. As used herein, “zero-power communication device” can refer to a fully passive communication device, a semi-passive communication device, or an active communication device. A zero-power communication device may obtain and store energy for transmission by performing energy harvesting and storage. For example, a zero-power communication device may store harvested energy (e.g., harvested using wind energy harvesting, solar energy harvesting, radio wave energization, or the like) using a storage module such as a capacitor. In some aspects, a zero-power communication device's storage module may be non-removable, as compared to removable energy storage such as a button cell. A passive communication device (e.g., a fully passive communication device) may communicate using, for example, backscatter communication without performing energy harvesting or storage. A semi-passive communication device may communicate using, for example, backscatter communication and may perform energy harvesting and storage. An active communication device may communicate using active (e.g., self-powered) transmission, and in some aspects may perform energy harvesting and storage. A zero-power communication device may communicate as a passive communication device (e.g., using backscatter communication), an active communication device (e.g., using a transmission powered by energy harvesting), or both. In some aspects, the zero-power communication devices described herein may perform envelope decoding or detection for receiving. An envelope detector (sometimes called a peak detector) is an electronic circuit that takes a (relatively) high-frequency amplitude modulated signal as input and provides an output, which is the demodulated envelope of the original signal. For example, a zero-power communication device may perform envelope detection using an envelope detector. A semi-passive communication device may also be referred to as a hybrid communication device. A passive communication device, a semi-passive communication device, a hybrid communication device, an active communication device, or a zero-power communication device may be referred to herein as a device.

In some examples, a zero-power communication device may include a passive IoT device. Zero-power communication devices may use passive communication technologies such as backscatter communication, which reduces power consumption and cost. One example of a zero-power communication device is an ultra-high frequency radio frequency identification (UHF RFID) tag, which may utilize backscatter communication. A zero-power communication device may not have sufficient transmit power or reception capabilities to communicate directly with a network node. For example, the zero-power communication device may communicate with a UE, and the UE may facilitate operations of the zero-power communication device. In some aspects, a zero-power communication device may include a tag such as an RFID tag.

As shown by reference number 410, in some examples, a UE and a zero-power communication device may communicate in uplink slots. For example, the UE may transmit a communication (which may be carried on a carrier wave (CW)) to the passive communication device, or the zero-power communication device may transmit a communication to the UE, in one or more uplink slots. In some examples, the carrier wave may power up the zero-power communication device. In some examples, the UE and the zero-power communication device may communicate in a slot other than an uplink slot, such as a slot designated for zero-power device communication, a sidelink slot, or the like. In some examples, the carrier wave is an unmodulated wave such as a single-tone unmodulated wave. In some aspects, the carrier wave is a modulated wave.

A voltage of the zero-power communication device of example 400 is shown by reference number 415. In some aspects, the voltage may be an integrated circuit (IC) voltage. The passive communication device may be associated with a voltage threshold, shown by reference number 425. The zero-power communication device may be capable of communicating if (e.g., while) the voltage of the zero-power communication device satisfies the voltage threshold. The voltage threshold is illustrated as a “turn-on voltage” (e.g., a voltage at which the zero-power communication device turns on, or turns on one or more components, for communication).

In example 400, the zero-power communication device's voltage increases in a first time period shown by reference number 435, such as due to harvesting energy or being energized for backscatter communication. The zero-power communication device's voltage increases to satisfy the voltage threshold for a period of time, then drops below the voltage threshold, as shown by reference number 440, such as due to ceasing energy harvesting or ceasing energization for backscatter communication. As shown by reference number 445, the zero-power communication device's voltage again increases to satisfy the voltage threshold.

Communication by zero-power communication devices (as in example 400) may benefit from a continuous time resource allocation (e.g., a resource allocation occupying continuous time resources), since the windows of time in which a zero-power communication device satisfies the voltage threshold can be unpredictable due to the passive nature of the zero-power communication device's communications.

Additionally, or alternatively, a network node may schedule communications of a zero-power communication device to include a time window for powering up the passive communication device. Communication by semi-passive communication devices may use a discontinuous time resource allocation, since the energy harvesting nature of a semi-passive communication device may provide some stability regarding times at which the semi-passive communication device's voltage satisfies the voltage threshold. In some aspects, as described elsewhere herein, a UE may report a number of zero-power communication devices associated with the UE, such that the network node can allocate suitable resources accordingly. In some aspects, the number of zero-power communication devices may be implicitly indicated by unicast, groupcast, or broadcast signaling. In some aspects, as described elsewhere herein, the UE may report a device type of one or more zero-power communication devices associated with the UE.

As indicated above, FIG. 4 is provided as an example. Other examples may differ from what is described with regard to FIG. 4.

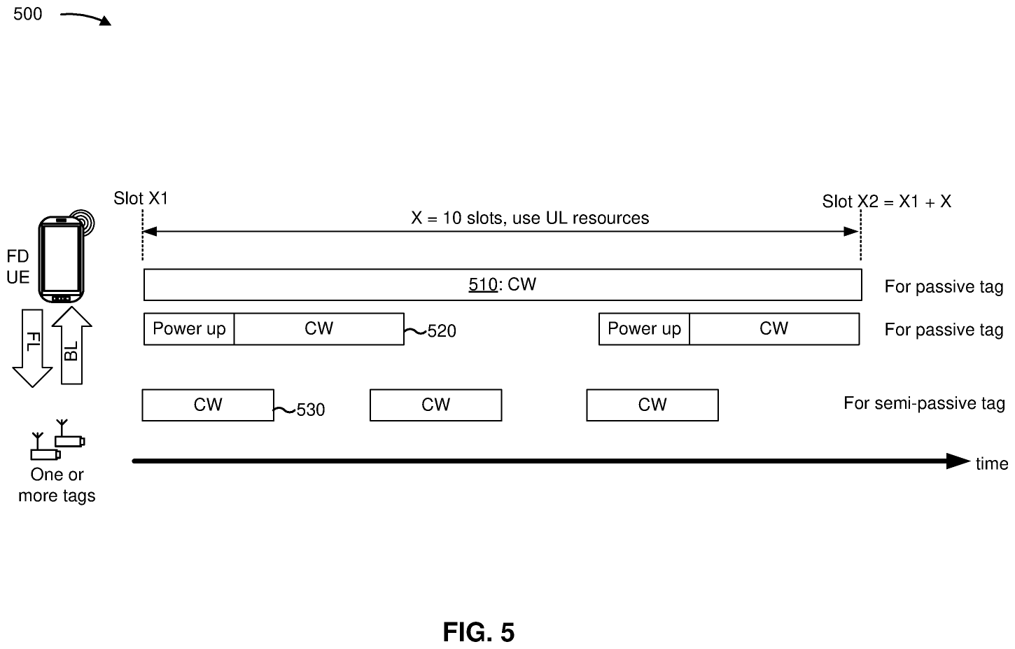

FIG. 5 is a diagram illustrating an example 500 of resource allocations for zero-power communication devices, in accordance with the present disclosure. Example 500 includes a UE (e.g., UE 120) and one or more zero-power communication devices (illustrated in FIG. 5 as “tags”). In some aspects, the UE is capable of full-duplex (FD) communication. Transmissions from the UE to a zero-power communication device may be referred to as occurring on a forward link (FL), and transmissions from a zero-power communication device to the UE may be referred to as occurring on a backward link (BL). In example 500, the horizontal axis represents time. Reference number 510 shows a continuous resource allocation. Reference numbers 520 and 530 show discontinuous resource allocations. For example, the continuous resource allocation shown by reference number 510 may be useful for fully passive communication devices, as described in connection with FIG. 4. For example, the discontinuous resource allocation shown by reference number 520 may be useful for fully passive communication devices, and may include a time window in which a fully passive communication device can power up, as described in connection with FIG. 4. For example, the discontinuous resource allocation shown by reference number 530 may be useful for semi-passive or active communication devices.

A network node may allocate resources, such as resources for communications associated with a zero-power communication device, based at least in part on a buffer status report (BSR). A BSR is a set of information (such as a medium access control control element (MAC-CE)) indicating a buffer status associated with a UE. In some examples, a BSR indicates a volume of uplink data that the UE is ready to transmit. For example, the BSR may include a value indicating a volume of uplink data (such as a value indicating an index of a table that identifies volumes of uplink data). A UE can use a BSR to request a resource allocation for communications associated with the UE. A BSR for such a purpose may be referred to as a scheduling request BSR. A network node may provide a grant indicating a resource allocation based at least in part on the BSR. In some aspects, a UE may use granted resources for communication with one or more passive communication devices. For example, the resources shown by reference numbers 410, 510, 520, and/or 530 may be granted based at least in part on a BSR from a UE associated with the passive communication devices of FIGS. 4 and 5.

A legacy BSR, such as may be used for Uu communications, may include a number of fields, such as one or more logical channel group (LCG) identifier fields and one or more buffer size fields. The buffer size field may use, for example, 5 bits in a short BSR or 8 bits (or multiple fields with 8 bits) in a long BSR. The LCG identifier field may use 3 bits in a short BSR or 8 bits (with each bit corresponding to a different LCG) in a long BSR.

It may be beneficial for a network node to have information regarding one or more devices associated with a UE, such as one or more zero-power communication devices, in order to determine a grant for the UE. For example, the network node may use information regarding a quantity of devices and/or a device type of one or more devices to determine a grant for the UE. For example, the network node may provide a grant of a larger resource allocation for a larger quantity of devices. As another example, the network node may provide a continuous resource allocation or a discontinuous resource allocation with a power-up time for a fully passive communication device, or may provide a discontinuous resource allocation for a semi-passive or active communication device. However, legacy BSRs may not be capable of conveying information regarding the one or more devices associated with the UE, such as due to overhead constraints and/or incompatibility with other UEs. Without information regarding one or more devices associated with a UE, scheduling of resources for the UE may be sub-optimal and may negatively affect operation of devices such as zero-power communication devices.

Some techniques described herein provide a MAC-CE associated with communication between a UE and one or more devices (such as one or more zero-power communication devices) associated with the UE. At least one of an LCG field (if present in the MAC-CE) or a buffer size field of the MAC-CE (if present in the MAC-CE) may be based at least in part on the MAC-CE being associated with communication between the UE and the one or more devices. The MAC-CE associated with communication between the UE and one or more devices is referred to as a zero-power communication BSR MAC-CE for brevity, though it should be understood that the zero-power communication BSR MAC-CE can convey information regarding non-passive communication devices. By providing the zero-power communication BSR MAC-CE, the UE can convey information regarding the one or more devices associated with the UE, such as a quantity of the one or more devices, a device type of the one or more devices, or the like. Thus, scheduling of resources for UEs associated with passive communication devices is improved, and the operation of passive communication devices (such as communications and energy harvesting) is improved.

As indicated above, FIG. 5 is provided as an example. Other examples may differ from what is described with regard to FIG. 5.

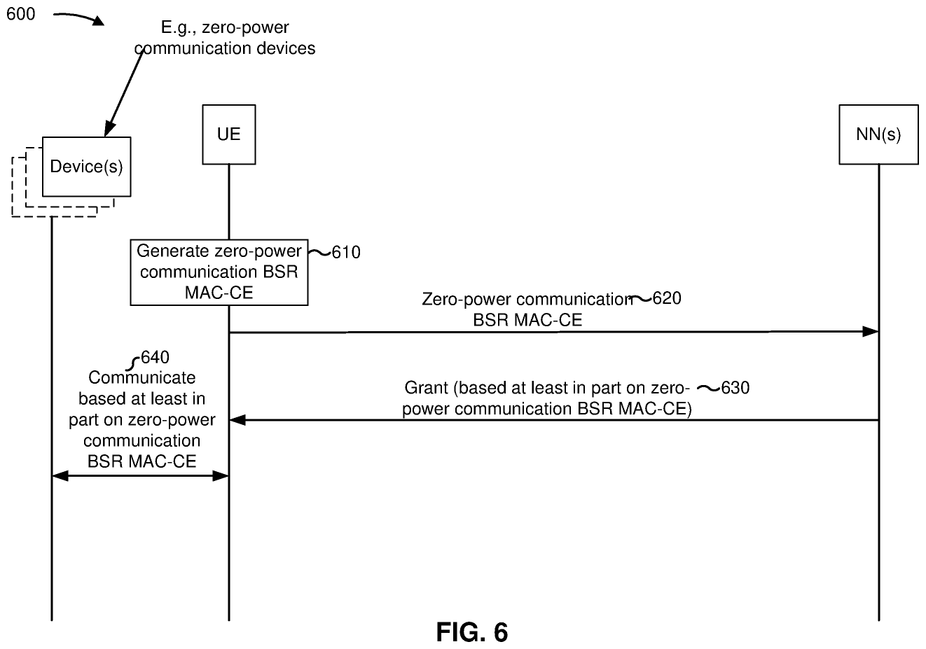

FIG. 6 is a diagram illustrating an example 600 of signaling associated with a zero-power communication BSR MAC-CE, in accordance with the present disclosure. As shown, example 600 includes a UE (e.g., UE 120), one or more devices (e.g., one or more UEs 120, one or more zero-power communication devices as described with regard to FIGS. 4 and 5), and a network node (e.g., network node 110). The network node may comprise a CU, a DU, an RU, or a combination thereof. For example, the network node illustrated in FIG. 6 may comprise multiple network nodes that may, or may not, be co-located. Functions of the network node of example 600 may be implemented according to one of various functional splits, as described elsewhere herein.

In some aspects, the UE may identify the one or more devices. For example, the UE may establish a connection with the one or more devices. As another example, the UE may discover (e.g., detect) the one or more devices. As yet another example, the UE may be configured with information identifying the one or more devices.

As shown by reference number 610, the UE may generate a zero-power communication BSR MAC-CE. For example, a MAC layer of the UE may generate the zero-power communication BSR MAC-CE. In some aspects, the UE may generate the zero-power communication BSR MAC-CE based at least in part on a communication with the one or more devices. For example, the UE may identify one or more parameters, such as a buffer size of the communication, a communication type of the communication (e.g., unicast communication, broadcast communication, or groupcast communication), a number of communications with the one or more devices, or the like. The UE may generate the zero-power communication BSR MAC-CE based at least in part on the one or more parameters. For example, the UE may generate a zero-power communication BSR MAC-CE that includes one or more values indicating the one or more parameters, as described below. As shown by reference number 620, the UE may transmit the zero-power communication BSR MAC-CE. For example, the UE may transmit a physical uplink shared channel (PUSCH) carrying the zero-power communication BSR MAC-CE. The network node (e.g., an RU of the network node or an RU associated with the network node) may receive the PUSCH carrying the zero-power communication BSR MAC-CE. The network node (e.g., a MAC layer of the network node, which may be located at an RU of the network node, a DU of the network node, or a CU of the network node) may obtain the zero-power communication BSR MAC-CE.

The zero-power communication BSR MAC-CE may be associated with communication between the UE and the one or more devices. For example, the zero-power communication BSR MAC-CE may include a header or another field indicating that the zero-power communication BSR MAC-CE is associated with communication between the UE and the one or more devices. As another example, one or more fields of the zero-power communication BSR MAC-CE may be sized and/or configured according to a size or configuration for BSR MAC-CEs used to indicate one or more parameters associated with the one or more devices. Thus, the network node can determine that the zero-power communication BSR MAC-CE is for communication with the one or more devices (such as passive IoT communication) as opposed to Uu communication with the network node or another network node.

The zero-power communication BSR MAC-CE may include a buffer size field. The buffer size field may be based at least in part on the zero-power communication BSR MAC-CE being associated with communication between the UE and the one or more devices. For example, a size of the buffer size field (e.g., a number of bits of the buffer size field) may be based at least in part on the zero-power communication BSR MAC-CE being associated with communication between the UE and the one or more devices. In this example, the buffer size field may have a first number of bits and a buffer size field associated with Uu communication (e.g., uplink communication with a network node) of the UE may have a second number of bits. The first number of bits may be smaller than the second number of bits. For example, the buffer size field of the zero-power communication BSR MAC-CE may include 4 bits. Thus, the buffer size field may be smaller than a buffer size field for Uu communication (such as OFDM-Uu communication), which reduces overhead relative to the buffer size field for Uu communication. Furthermore, communications with zero-power communication devices may generally be small in size (e.g., generally in the range of hundreds of bytes, as compared to Uu communications which can include tens of thousands or hundreds of thousands of bytes), and storage at zero-power communication devices may generally be limited (e.g., approximately several kilobytes (kBs), so a smaller buffer size field may provide sufficient addressable buffer size while reducing overhead.

The buffer size field of the zero-power communication BSR MAC-CE may indicate a buffer size. In some aspects, the zero-power communication BSR MAC-CE may indicate the buffer size by reference to a table. In some aspects, the table may be specific to zero-power communication BSR MAC-CEs. For example, BSR MAC-CEs for Uu communication may use a first table, and zero-power communication BSR MAC-CEs may use a second table different than the first table. In some aspects, the table may include part of a table for BSR MAC-CEs for Uu communication. As just one example, BSR MAC-CEs for Uu communication may use Table 1, and zero-power communication BSR MAC-CEs (using a 4-bit buffer size field) may use Table 2, illustrated below:

TABLE 1
Buffer size levels (in bytes) for 5-bit Buffer Size field.

| Index | BS value | Index | BS value | Index | BS value | Index | BS value |
|---|---|---|---|---|---|---|---|
| 0 | 0 | 8 | ≤102 | 16 | ≤1446 | 24 | ≤20516 |
| 1 | ≤10 | 9 | ≤142 | 17 | ≤2014 | 25 | ≤28581 |
| 2 | ≤14 | 10 | ≤198 | 18 | ≤2806 | 26 | ≤39818 |
| 3 | ≤20 | 11 | ≤276 | 19 | ≤3909 | 27 | ≤55474 |
| 4 | ≤28 | 12 | ≤384 | 20 | ≤5446 | 28 | ≤77284 |
| 5 | ≤38 | 13 | ≤535 | 21 | ≤7587 | 29 | ≤107669 |
| 6 | ≤53 | 14 | ≤745 | 22 | ≤10570 | 30 | ≤150000 |
| 7 | ≤74 | 15 | ≤1038 | 23 | ≤14726 | 31 | >150000 |

TABLE 2
Buffer size levels (in bytes) for 4-bit Buffer Size field.

| Index | BS value | Index | BS value |
|---|---|---|---|
| 0 | 0 | 8 | ≤102 |
| 1 | ≤10 | 9 | ≤142 |
| 2 | ≤14 | 10 | ≤198 |
| 3 | ≤20 | 11 | ≤276 |
| 4 | ≤28 | 12 | ≤384 |
| 5 | ≤38 | 13 | ≤535 |
| 6 | ≤53 | 14 | ≤745 |
| 7 | ≤74 | 15 | ≤1038 |

As shown, Table 2 provides an indication of a subset of buffer sizes compared to Table 1. Thus, the buffer size field of a zero-power communication BSR MAC-CE can indicate up to a first buffer size (in Table 2, 1038 bytes) and a buffer size field associated with Uu communication of the UE can indicate a second buffer size (in Table 1, greater than 150000 bytes, or 150000 bytes). It should be noted that Table 2 is provided as an example, and one or more buffer sizes of Table 2, or the number of entries and indexes included in Table 2, can vary. For example, the buffer size field of the zero-power communication BSR MAC-CE may include fewer than 4 bits.

In some aspects, the zero-power communication BSR MAC-CE may omit a buffer size field. In some aspects, the zero-power communication BSR MAC-CE may indicate a command associated with communication between the UE and the one or more devices, such as a read command to read data from a device, a write command to write data to a device, a start command for a communication, an end command for a communication, or a query regarding a state of a device. Additionally, or alternatively, the zero-power communication BSR MAC-CE may indicate an information type associated with the communication. For example, the zero-power communication BSR MAC-CE may indicate an information type in a buffer of the UE, an information type to be communicated between the UE and a device, or the like. The network node may determine a grant (such as a resource allocation) based at least in part on the command (e.g., a size associated with the command) or the information type (e.g., a size associated with a communication using the information type).

In some aspects, the zero-power communication BSR MAC-CE may indicate a quantity of devices, of the one or more devices. For example, the zero-power communication BSR MAC-CE (in some examples, a buffer size field of the zero-power communication BSR MAC-CE) may include a field indicating the quantity of devices. In some aspects, the field may explicitly indicate the quantity of devices. In some aspects, the field may indicate a range of numbers. The range of numbers may include the quantity of devices. For example, if there are 50 devices, the field may indicate an index corresponding to a range of numbers (e.g., 25-75, 1-100, or another range), selected from a plurality of ranges of numbers, that includes the quantity of devices (e.g., 50). Thus, overhead of the zero-power communication BSR MAC-CE can be reduced relative to explicitly indicating the quantity of devices.

In some aspects, the zero-power communication BSR MAC-CE may have a first field indicating a device type (e.g., passive, semi-passive, a combination of passive and semi-passive), a second field (e.g., including three bits) indicating a buffer size, and a third field indicating a quantity of devices. For example, a first value of the third field may indicate zero devices (e.g., that no device needs a response from the UE), a second value of the third field may indicate one device (e.g., for unicast communication), a third value of the third field may indicate a first range of numbers (e.g., 1-10 devices), a fourth value of the third field may indicate a second range of numbers (e.g., 11-100 devices), and/or a fifth value of the third field may indicate an unknown quantity of devices.

In some aspects, the zero-power communication BSR MAC-CE may include an LCG field. An LCG is a group of logical channels. A BSR (e.g., a BSR associated with Uu communication) may indicate a buffer size associated with a particular LCG. The particular LCG may be identified by an LCG field of a BSR. In some aspects, the LCG field of the zero-power communication BSR MAC-CE may be smaller than an LCG field of a BSR MAC-CE associated with Uu communication. For example, the LCG field of the zero-power communication BSR MAC-CE may have a first number of bits and an LCG field associated with Uu communication of the UE (e.g., an LCG field of a BSR MAC-CE associated with Uu communication) may have a second number of bits, wherein the first number of bits is smaller than the second number of bits. In one example, the first number of bits may be 1 bit, meaning that the zero-power communication BSR MAC-CE can indicate 2 LCGs. In some aspects, the zero-power communication BSR MAC-CE may omit an LCG field. For example, the zero-power communication BSR MAC-CE may not include an LCG field.

As shown by reference number 630, the network node (e.g., an RU of or associated with the network node) may transmit a grant. For example, the network node may output (e.g., transmit or provide for transmission) one or more grants. The grant may indicate a resource allocation. For example, the network node (e.g., a DU of the network node) may determine the grant and/or the resource allocation based at least in part on the zero-power communication BSR MAC-CE. In some aspects, a number and/or arrangement of resources of the resource allocation may be based at least in part on the buffer size indicated by the zero-power communication BSR MAC-CE. In some aspects, a number and/or arrangement of resources of the resource allocation may be based at least in part on an LCG indicated by the zero-power communication BSR MAC-CE. In some aspects, a number and/or arrangement of resources of the resource allocation may be based at least in part on a device type of the one or more devices. For example, the network node may provide continuous resources for a fully passive communication device, or may provide discontinuous resources for a semi-passive or active communication device. In some aspects, a number of resources of the resource allocation may be based at least in part on a quantity of devices of the one or more devices. For example, the network node may provide a larger resource allocation for a larger quantity of devices, and may provide a smaller resource allocation for a smaller quantity of devices. In some aspects, a number and/or arrangement of resources of the resource allocation may be based at least in part on an information type or a command indicated by the zero-power communication BSR MAC-CE. For example, the network node may determine the number of resources of the resource allocation based at least in part on a size associated with the information type or the command.

As shown by reference number 640, the UE may communicate based at least in part on the zero-power communication BSR MAC-CE. For example, the UE may receive the grant transmitted by the network node. The UE may communicate with the one or more devices based at least in part on the zero-power communication BSR MAC-CE. For example, the UE may transmit a communication to a device using a resource indicated by the grant. As another example, the UE may receive a communication from a device using a resource indicated by the grant. Thus, the UE may use one or more grants, outputted by the network node, for communication with the one or more devices. In this way, the UE can report one or more parameters, associated with the one or more devices, to the zero-power communication BSR MAC-CE. The network node may use the one or more parameters to determine and/or output a grant for the UE. The grant may indicate resources used for communication between the UE and the one or more devices. Thus, operation and efficiency of the one or more devices are improved, and overhead associated with BSR transmission is reduced.

As indicated above, FIG. 6 is provided as an example. Other examples may differ from what is described with regard to FIG. 6.

FIG. 7 is a flowchart of an example method 700 of wireless communication. The method 700 may be performed by, for example, a UE (e.g., UE 120).

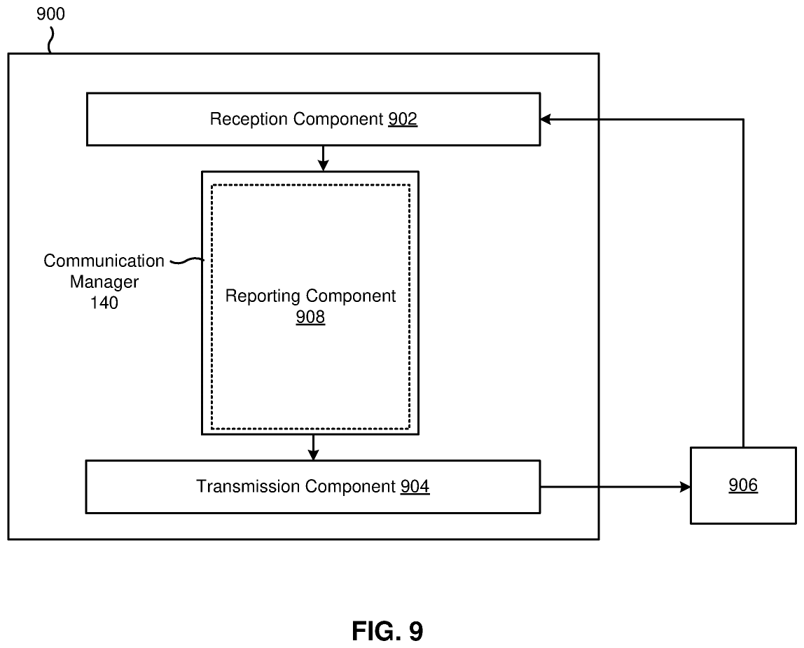

At 710, the UE may generate a MAC-CE associated with communication between the UE and one or more devices associated with the UE. For example, the UE (e.g., using communication manager 140, reporting component 908 depicted in FIG. 9, or a MAC entity) may generate a MAC-CE associated with communication between the UE and one or more devices associated with the UE. The MAC-CE is sometimes referred to herein as a zero-power communication BSR MAC-CE. In some aspects, the one or more devices include at least one zero-power communication device. For example, the one or more devices may be one or more zero-power communication devices.

At 720, the UE may transmit the MAC-CE associated with communication between the UE and one or more devices associated with the UE, wherein at least one of an LCG field or a buffer size field of the MAC-CE is based at least in part on the MAC-CE being associated with communication between the UE and the one or more devices. For example, the UE (e.g., using communication manager 140 and/or transmission component 904, depicted in FIG. 9) may transmit a MAC-CE associated with communication between the UE and one or more devices associated with the UE. At least one of an LCG field (if present) or a buffer size field (if present) of the MAC-CE is based at least in part on the MAC-CE being associated with communication between the UE and the one or more devices, as described above in connection with, for example, FIG. 6 and at 610 and 620. In some aspects, the MAC-CE indicates a device type of the one or more devices.

In some aspects, the buffer size field has a first number of bits and a buffer size field associated with Uu communication of the UE has a second number of bits, wherein the first number of bits is smaller than the second number of bits. In some aspects, the buffer size field can indicate up to a first buffer size, and a buffer size field associated with Uu communication of the UE can indicate up to a second buffer size, wherein the first buffer size is smaller than the second buffer size.

In some aspects, the buffer size field indicates a command associated with the communication. In some aspects, the buffer size field indicates an information type associated with the communication, wherein the information type includes at least one of a read information type, a write information type, an information type indicating a start of the communication, or an information type indicating an end of the communication. In some aspects, the buffer size field includes a field indicating a quantity of devices of the one or more devices. In some aspects, the field indicates a range of numbers, selected from a plurality of ranges of numbers, that includes the quantity of devices.

In some aspects, the LCG field has a first number of bits and an LCG field associated with Uu communication of the UE has a second number of bits, wherein the first number of bits is smaller than the second number of bits. In some other aspects, the MAC-CE omits the LCG field based at least in part on the MAC-CE being associated with communication between the UE and the one or more devices.

At 730, the UE may communicate based at least in part on the MAC-CE. For example, the UE (e.g., using communication manager 140 and/or transmission component 904, depicted in FIG. 9) may communicate based at least in part on the MAC-CE, as described above in connection with, for example, FIG. 6 and at 640. In some aspects, the UE may transmit a communication to one or more devices. In some aspects, the UE may transmit a carrier wave to the one or more devices. In some aspects, the UE may receive a communication from the one or more devices. In some aspects, communicating based at least in part on the MAC-CE further comprises performing the communication with the one or more devices. In some aspects, the communication uses one or more grants associated with the MAC-CE.

Although FIG. 7 shows example blocks of method 700, in some aspects, method 700 may include additional blocks, fewer blocks, different blocks, or differently arranged blocks than those depicted in FIG. 7. Additionally, or alternatively, two or more of the blocks of method 700 may be performed in parallel.

FIG. 8 is a flowchart of an example method 800 of wireless communication. The method 800 may be performed by, for example, a network node or a group of network nodes (e.g., network node 110).

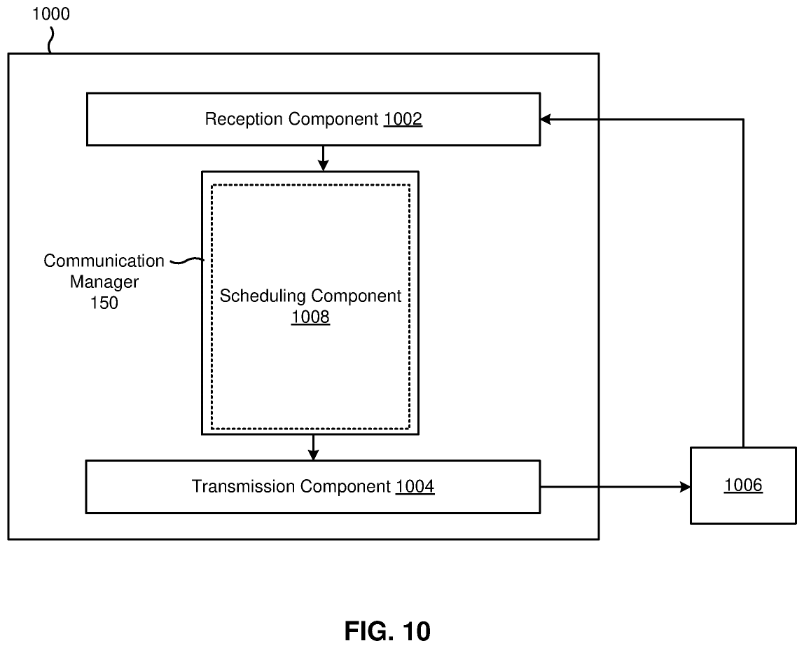

At 810, the network node may obtain a MAC-CE associated with communication between a UE and one or more devices associated with the UE, wherein at least one of an LCG field or a buffer size field of the MAC-CE is based at least in part on the MAC-CE being associated with communication between the UE and the one or more devices. For example, the network node (e.g., using communication manager 150 and/or reception component 1002, depicted in FIG. 10) may obtain a MAC-CE associated with communication between a UE and one or more devices associated with the UE, wherein at least one of an LCG field or a buffer size field of the MAC-CE is based at least in part on the MAC-CE being associated with communication between the UE and the one or more devices, as described above in connection with, for example, FIG. 6 and at 620. In some aspects, the MAC-CE indicates a device type of the one or more devices.

In some aspects, the buffer size field has a first number of bits and a buffer size field associated with Uu communication of the UE has a second number of bits, wherein the first number of bits is smaller than the second number of bits. In some aspects, the buffer size field can indicate up to a first buffer size and a buffer size field associated with Uu communication of the UE can indicate up to a second buffer size, wherein the first buffer size is smaller than the second buffer size.

In some aspects, the LCG field has a first number of bits and an LCG field associated with Uu communication of the UE has a second number of bits, wherein the first number of bits is smaller than the second number of bits. In some aspects, the MAC-CE omits the LCG field based at least in part on the MAC-CE being associated with communication between the UE and the one or more devices.

In some aspects, the one or more devices include at least one zero-power communication device.

In some aspects, the buffer size field indicates a command associated with the communication. In some aspects, the buffer size field indicates an information type associated with the communication, wherein the information type includes at least one of a read information type, a write information type, an information type indicating a start of the communication, or an information type indicating an end of the communication. In some aspects, the buffer size field includes a field indicating a quantity of devices of the one or more devices. In some aspects, the field indicates a range of numbers, selected from a plurality of ranges of numbers, that includes the quantity of devices.

At 820, the network node may generate one or more grants based at least in part on the MAC-CE. For example, the network node (e.g., using communication manager 150 and/or scheduling component 1008, depicted in FIG. 10) may generate one or more grants. The one or more grants, and/or one or more resource allocations of the one or more grants, may be based at least in part on the MAC-CE, as described in connection with FIG. 6 at 630.

At 830, the network node may output one or more grants based at least in part on the MAC-CE. For example, the network node (e.g., using communication manager 150 and/or transmission component 1004, depicted in FIG. 10) may output (e.g., transmit or provide for transmission) one or more grants based at least in part on the MAC-CE, as described above in connection with, for example, FIG. 6 and at 630.

Although FIG. 8 shows example blocks of method 800, in some aspects, method 800 may include additional blocks, fewer blocks, different blocks, or differently arranged blocks than those depicted in FIG. 8. Additionally, or alternatively, two or more of the blocks of method 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, a zero-power communication device, or another wireless communication device) using the reception component 902 and the transmission component 904. As further shown, the apparatus 900 may include the communication manager 140. The communication manager 140 may include a reporting component 908, among other examples.

In some aspects, the apparatus 900 may be configured to perform one or more operations described herein in connection with FIGS. 3-6. Additionally, or alternatively, the apparatus 900 may be configured to perform one or more processes described herein, such as method 700 of FIG. 7, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The transmission component 904 or the reporting component 908 may transmit a MAC-CE associated with communication between the UE and one or more devices associated with the UE, wherein at least one of an LCG field or a buffer size field of the MAC-CE is based at least in part on the MAC-CE being associated with communication between the UE and the one or more devices. The transmission component 904 may communicate based at least in part on the MAC-CE.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a network node, or a wireless communication device) using the reception component 1002 and the transmission component 1004. As further shown, the apparatus 1000 may include the communication manager 150. The communication manager 150 may include a scheduling component 1008, among other examples.

In some aspects, the apparatus 1000 may be configured to perform one or more operations described herein in connection with FIGS. 3-6. Additionally, or alternatively, the apparatus 1000 may be configured to perform one or more processes described herein, such as method 800 of FIG. 8, or a combination thereof. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver. In some aspects, the reception component 1002 and/or the transmission component 1004 may communicate via a transceiver (e.g., transceiver 1230). Additionally, or alternatively, the reception component 1002 and/or the transmission component 1004 may communicate via a network interface (e.g., network interface 1240).

The reception component 1002 may obtain a MAC-CE associated with communication between a UE and one or more devices associated with the UE, wherein at least one of an LCG field or a buffer size field of the MAC-CE is based at least in part on the MAC-CE being associated with communication between the UE and the one or more devices. The scheduling component 1008 may generate one or more grants. The transmission component 1004 may output one or more grants based at least in part on the MAC-CE.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

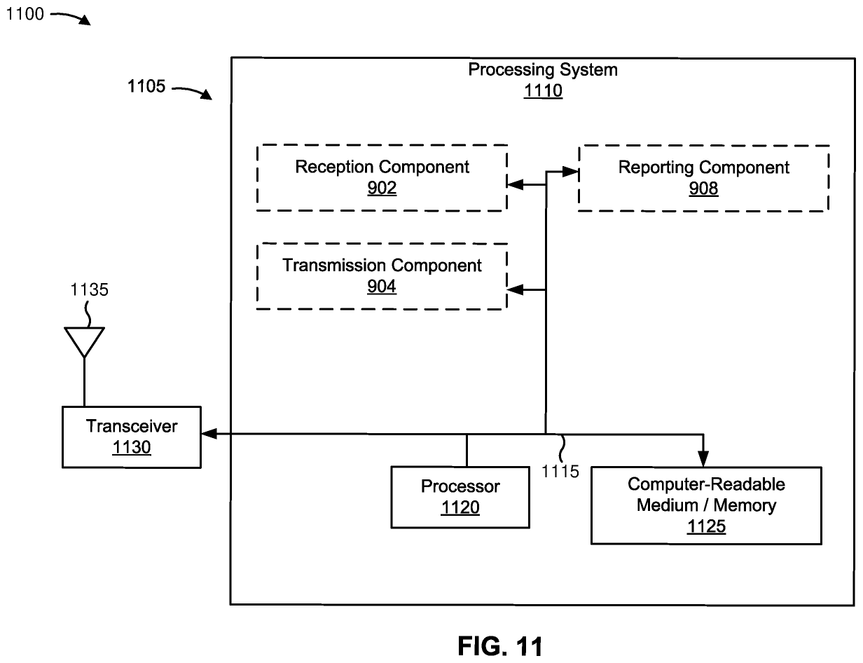

FIG. 11 is a diagram illustrating an example 1100 of a hardware implementation for an apparatus 1105 employing a processing system 1110, in accordance with the present disclosure. The apparatus 1105 may be a UE.

The processing system 1110 may be implemented with a bus architecture, represented generally by the bus 1115. The bus 1115 may include any number of interconnecting buses and bridges depending on the specific application of the processing system 1110 and the overall design constraints. The bus 1115 links together various circuits including one or more processors and/or hardware components, represented by the processor 1120, the illustrated components, and the computer-readable medium/memory 1125. The bus 1115 may also link various other circuits, such as timing sources, peripherals, voltage regulators, and/or power management circuits.

The processing system 1110 may be coupled to a transceiver 1130. The transceiver 1130 is coupled to one or more antennas 1135. The transceiver 1130 provides a means for communicating with various other apparatuses over a transmission medium. The transceiver 1130 receives a signal from the one or more antennas 1135, extracts information from the received signal, and provides the extracted information to the processing system 1110, specifically the reception component 902. In addition, the transceiver 1130 receives information from the processing system 1110, specifically the transmission component 904, and generates a signal to be applied to the one or more antennas 1135 based at least in part on the received information.

The processing system 1110 includes a processor 1120 coupled to a computer-readable medium/memory 1125. The processor 1120 is responsible for general processing, including the execution of software stored on the computer-readable medium/memory 1125. The software, when executed by the processor 1120, causes the processing system 1110 to perform the various functions described herein for any particular apparatus. The computer-readable medium/memory 1125 may also be used for storing data that is manipulated by the processor 1120 when executing software. The processing system further includes at least one of the illustrated components. The components may be software modules running in the processor 1120, resident/stored in the computer readable medium/memory 1125, one or more hardware modules coupled to the processor 1120, or some combination thereof.

In some aspects, the processing system 1110 may be a component of the UE 120 and may include the memory 282 and/or at least one of the TX MIMO processor 266, the RX processor 258, and/or the controller/processor 280. In some aspects, the apparatus 1105 for wireless communication includes means for transmitting a MAC-CE associated with communication between the UE and one or more devices associated with the UE, wherein at least one of an LCG field or a buffer size field of the MAC-CE is based at least in part on the MAC-CE being associated with communication between the UE and the one or more devices; and/or means for communicating based at least in part on the MAC-CE. The aforementioned means may be one or more of the aforementioned components of the apparatus 900 and/or the processing system 1110 of the apparatus 1105 configured to perform the functions recited by the aforementioned means. As described elsewhere herein, the processing system 1110 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 11 is provided as an example. Other examples may differ from what is described in connection with FIG. 11.

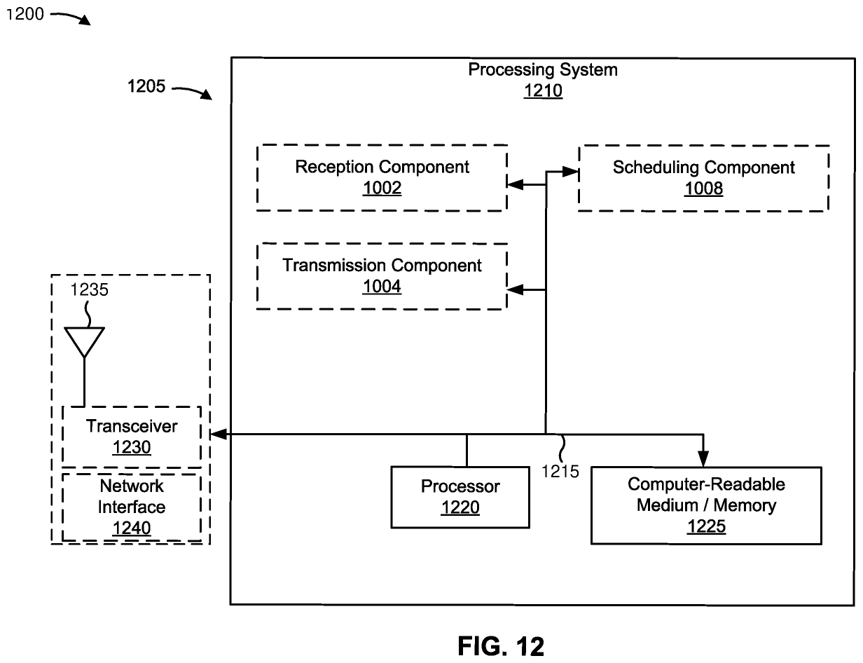

FIG. 12 is a diagram illustrating an example 1200 of a hardware implementation for an apparatus 1205 employing a processing system 1210, in accordance with the present disclosure. The apparatus 1205 may be a network node or a group of network nodes.

The processing system 1210 may be implemented with a bus architecture, represented generally by the bus 1215. The bus 1215 may include any number of interconnecting buses and bridges depending on the specific application of the processing system 1210 and the overall design constraints. The bus 1215 links together various circuits including one or more processors and/or hardware components, represented by the processor 1220, the illustrated components, and the computer-readable medium/memory 1225. The bus 1215 may also link various other circuits, such as timing sources, peripherals, voltage regulators, and/or power management circuits.

In some examples, the processing system 1210 may be coupled to a transceiver 1230. The transceiver 1230 is coupled to one or more antennas 1235. The transceiver 1230 provides a means for communicating with various other apparatuses over a transmission medium. The transceiver 1230 receives a signal from the one or more antennas 1235, extracts information from the received signal, and provides the extracted information to the processing system 1210, specifically the reception component 1002. In addition, the transceiver 1230 receives information from the processing system 1210, specifically the transmission component 1004, and generates a signal to be applied to the one or more antennas 1235 based at least in part on the received information. In some examples, the processing system 1210 may be coupled to a network interface 1240. The network interface 1240 is configured to obtain and send signals for the apparatus 1205 via communications link(s), such as a backhaul link, midhaul link, and/or fronthaul link as described herein, such as with respect to FIG. 3. The network interface 1240 provides a means for communicating with various other apparatuses (e.g., outputting and/or obtaining information) over one or more communications links.

The processing system 1210 includes a processor 1220 coupled to a computer-readable medium/memory 1225. The processor 1220 is responsible for general processing, including the execution of software stored on the computer-readable medium/memory 1225. The software, when executed by the processor 1220, causes the processing system 1210 to perform the various functions described herein for any particular apparatus. The computer-readable medium/memory 1225 may also be used for storing data that is manipulated by the processor 1220 when executing software. The processing system further includes at least one of the illustrated components. The components may be software modules running in the processor 1220, resident/stored in the computer readable medium/memory 1225, one or more hardware modules coupled to the processor 1220, or some combination thereof.

In some aspects, the processing system 1210 may be a component of the network node 110 and may include the memory 242 and/or at least one of the TX MIMO processor 230, the RX processor 238, and/or the controller/processor 240. In some aspects, the apparatus 1205 for wireless communication includes means for obtaining a MAC-CE associated with communication between a UE and one or more devices associated with the UE, wherein at least one of an LCG field or a buffer size field of the MAC-CE is based at least in part on the MAC-CE being associated with communication between the UE and the one or more devices; and/or means for outputting one or more grants based at least in part on the MAC-CE. The aforementioned means may be one or more of the aforementioned components of the apparatus 1000 and/or the processing system 1210 of the apparatus 1205 configured to perform the functions recited by the aforementioned means. As described elsewhere herein, the processing system 1210 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 12 is provided as an example. Other examples may differ from what is described in connection with FIG. 12.

The following provides an overview of some Aspects of the present disclosure:

Aspect 1: A method of wireless communication performed by a user equipment (UE), comprising: transmitting a medium access control (MAC) control element (MAC-CE) associated with communication between the UE and one or more devices associated with the UE, wherein at least one of a logical channel group (LCG) field or a buffer size field of the MAC-CE is based at least in part on the MAC-CE being associated with communication between the UE and the one or more devices; and communicating based at least in part on the MAC-CE.

Aspect 2: The method of Aspect 1, wherein the buffer size field has a first number of bits and a buffer size field associated with Uu communication of the UE has a second number of bits, wherein the first number of bits is smaller than the second number of bits.

Aspect 3: The method of any of Aspects 1-2, wherein the buffer size field can indicate up to a first buffer size and a buffer size field associated with Uu communication of the UE can indicate up to a second buffer size, wherein the first buffer size is smaller than the second buffer size.

Aspect 4: The method of any of Aspects 1-3, wherein the LCG field has a first number of bits and an LCG field associated with Uu communication of the UE has a second number of bits, wherein the first number of bits is smaller than the second number of bits.

Aspect 5: The method of any of Aspects 1-4, wherein the MAC-CE omits the LCG field based at least in part on the MAC-CE being associated with communication between the UE and the one or more devices.

Aspect 6: The method of any of Aspects 1-5, wherein the one or more devices include at least one of: one or more passive communication devices, one or more semi-passive communication devices, or one or more zero-power tags.

Aspect 7: The method of any of Aspects 1-6, wherein the buffer size field indicates a command associated with the communication.

Aspect 8: The method of any of Aspects 1-7, wherein the buffer size field indicates an information type associated with the communication, wherein the information type includes at least one of: a read information type, a write information type, an information type indicating a start of the communication, or an information type indicating an end of the communication.

Aspect 9: The method of any of Aspects 1-8, wherein the buffer size field includes a field indicating a quantity of devices of the one or more devices.

Aspect 10: The method of Aspect 9, wherein the field indicates a range of numbers, selected from a plurality of ranges of numbers, that includes the quantity of devices.

Aspect 11: The method of any of Aspects 1-10, wherein communicating based at least in part on the MAC-CE further comprises performing the communication with the one or more devices.

Aspect 12: The method of Aspect 11, wherein the communication uses one or more grants associated with the MAC-CE.

Aspect 13: The method of any of Aspects 1-12, wherein the MAC-CE indicates a device type of the one or more devices.

Aspect 14: A method of wireless communication performed by a network node, comprising: obtaining a medium access control (MAC) control element (MAC-CE) associated with communication between a user equipment (UE) and one or more devices associated with the UE, wherein at least one of a logical channel group (LCG) field or a buffer size field of the MAC-CE is based at least in part on the MAC-CE being associated with communication between the UE and the one or more devices; and outputting one or more grants based at least in part on the MAC-CE.

Aspect 15: The method of Aspect 14, wherein the buffer size field has a first number of bits and a buffer size field associated with Uu communication of the UE has a second number of bits, wherein the first number of bits is smaller than the second number of bits.

Aspect 16: The method of any of Aspects 14-15, wherein the buffer size field can indicate up to a first buffer size and a buffer size field associated with Uu communication of the UE can indicate up to a second buffer size, wherein the first buffer size is smaller than the second buffer size.

Aspect 17: The method of any of Aspects 14-16, wherein the LCG field has a first number of bits and an LCG field associated with Uu communication of the UE has a second number of bits, wherein the first number of bits is smaller than the second number of bits.

Aspect 18: The method of any of Aspects 14-17, wherein the MAC-CE omits the LCG field based at least in part on the MAC-CE being associated with communication between the UE and the one or more devices.

Aspect 19: The method of any of Aspects 14-18, wherein the one or more devices include at least one of: one or more passive communication devices, one or more semi-passive communication devices, or one or more zero-power tags.

Aspect 20: The method of any of Aspects 14-19, wherein the buffer size field indicates a command associated with the communication.

Aspect 21: The method of any of Aspects 14-20, wherein the buffer size field indicates an information type associated with the communication, wherein the information type includes at least one of: a read information type, a write information type, an information type indicating a start of the communication, or an information type indicating an end of the communication.

Aspect 22: The method of any of Aspects 14-21, wherein the buffer size field includes a field indicating a quantity of devices of the one or more devices.

Aspect 23: The method of Aspect 22, wherein the field indicates a range of numbers, selected from a plurality of ranges of numbers, that includes the quantity of devices.

Aspect 24: The method of any of Aspects 14-23, wherein the MAC-CE indicates a device type of the one or more devices.

Aspect 25: An apparatus for wireless communication at a device, comprising a processor; memory coupled with the processor; and instructions stored in the memory and executable by the processor to cause the apparatus to perform the method of one or more of Aspects 1-24.

Aspect 26: A device for wireless communication, comprising a memory and one or more processors coupled to the memory, the one or more processors configured to perform the method of one or more of Aspects 1-24.

Aspect 27: An apparatus for wireless communication, comprising at least one means for performing the method of one or more of Aspects 1-24.

Aspect 28: A non-transitory computer-readable medium storing code for wireless communication, the code comprising instructions executable by a processor to perform the method of one or more of Aspects 1-24.

Aspect 29: A non-transitory computer-readable medium storing a set of instructions for wireless communication, the set of instructions comprising one or more instructions that, when executed by one or more processors of a device, cause the device to perform the method of one or more of Aspects 1-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
transmit a medium access control (MAC) control element (MAC-CE) associated with communication between the UE and one or more devices associated with the UE, wherein at least one of a logical channel group (LCG) field or a buffer size field of the MAC-CE is based at least in part on the MAC-CE being associated with communication between the UE and the one or more devices; and
communicate based at least in part on the MAC-CE.

2. The UE of claim 1, wherein the buffer size field has a first number of bits and a buffer size field associated with Uu communication of the UE has a second number of bits, wherein the first number of bits is smaller than the second number of bits.

3. The UE of claim 1, wherein the buffer size field can indicate up to a first buffer size and a buffer size field associated with Uu communication of the UE can indicate up to a second buffer size, wherein the first buffer size is smaller than the second buffer size.

4. The UE of claim 1, wherein the LCG field has a first number of bits and an LCG field associated with Uu communication of the UE has a second number of bits, wherein the first number of bits is smaller than the second number of bits.

5. The UE of claim 1, wherein the MAC-CE omits the LCG field based at least in part on the MAC-CE being associated with communication between the UE and the one or more devices.

6. The UE of claim 1, wherein the one or more devices include at least one zero-power communication device.

7. The UE of claim 1, wherein the buffer size field indicates a command associated with the communication.

8. The UE of claim 1, wherein the buffer size field indicates an information type associated with the communication.

9. The UE of claim 1, wherein the buffer size field includes a field indicating a quantity of devices of the one or more devices.

10. The UE of claim 9, wherein the field indicates a range of numbers, selected from a plurality of ranges of numbers, that includes the quantity of devices.

11. The UE of claim 1, wherein the one or more processors, to communicate based at least in part on the MAC-CE, are configured to perform the communication with the one or more devices.

12. The UE of claim 1, wherein the communication uses one or more grants associated with the MAC-CE.

13. The UE of claim 1, wherein the MAC-CE indicates a device type of the one or more devices.

14. A network node for wireless communication, comprising:
a memory; and
one or more processors, coupled to the memory, configured to:
obtain a medium access control (MAC) control element (MAC-CE) associated with communication between a user equipment (UE) and one or more devices associated with the UE, wherein at least one of a logical channel group (LCG) field or a buffer size field of the MAC-CE is based at least in part on the MAC-CE being associated with communication between the UE and the one or more devices; and
output one or more grants based at least in part on the MAC-CE.

15. The network node of claim 14, wherein the buffer size field has a first number of bits and a buffer size field associated with Uu communication of the UE has a second number of bits, wherein the first number of bits is smaller than the second number of bits.

16. The network node of claim 14, wherein the buffer size field can indicate up to a first buffer size and a buffer size field associated with Uu communication of the UE can indicate up to a second buffer size, wherein the first buffer size is smaller than the second buffer size.

17. The network node of claim 14, wherein the LCG field has a first number of bits and an LCG field associated with Uu communication of the UE has a second number of bits, wherein the first number of bits is smaller than the second number of bits.

18. The network node of claim 14, wherein the MAC-CE omits the LCG field based at least in part on the MAC-CE being associated with communication between the UE and the one or more devices.

19. The network node of claim 14, wherein the one or more devices include at least one zero-power communication device.

20. The network node of claim 14, wherein the buffer size field indicates a command associated with the communication.

21. The network node of claim 14, wherein the buffer size field indicates an information type associated with the communication.

22. The network node of claim 14, wherein the buffer size field includes a field indicating a quantity of devices of the one or more devices.

23. The network node of claim 22, wherein the field indicates a range of numbers, selected from a plurality of ranges of numbers, that includes the quantity of devices.

24. The network node of claim 14, wherein the MAC-CE indicates a device type of the one or more devices.

25. A method of wireless communication performed by a user equipment (UE), comprising:
transmitting a medium access control (MAC) control element (MAC-CE) associated with communication between the UE and one or more devices associated with the UE, wherein at least one of a logical channel group (LCG) field or a buffer size field of the MAC-CE is based at least in part on the MAC-CE being associated with communication between the UE and the one or more devices; and
communicating based at least in part on the MAC-CE.

26. The method of claim 25, wherein the buffer size field has a first number of bits and a buffer size field associated with Uu communication of the UE has a second number of bits, wherein the first number of bits is smaller than the second number of bits.

27. The method of claim 25, wherein the buffer size field can indicate up to a first buffer size and a buffer size field associated with Uu communication of the UE can indicate up to a second buffer size, wherein the first buffer size is smaller than the second buffer size.

28. A method of wireless communication performed by a network node, comprising:
obtaining a medium access control (MAC) control element (MAC-CE) associated with communication between a user equipment (UE) and one or more devices associated with the UE, wherein at least one of a logical channel group (LCG) field or a buffer size field of the MAC-CE is based at least in part on the MAC-CE being associated with communication between the UE and the one or more devices; and
outputting one or more grants based at least in part on the MAC-CE.

29. The method of claim 28, wherein the buffer size field has a first number of bits and a buffer size field associated with Uu communication of the UE has a second number of bits, wherein the first number of bits is smaller than the second number of bits.

30. The method of claim 28, wherein the buffer size field can indicate up to a first buffer size and a buffer size field associated with Uu communication of the UE can indicate up to a second buffer size, wherein the first buffer size is smaller than the second buffer size.
